(19) United States
(12) Patent Application Publication
(10) Pub. No.: US 2014/0373578 A1
(43) Pub. Date: Dec. 25, 2014

(54) PORTABLE SAFETY DEVICE WITH TWO LOCKS

(71) Applicant: YUN-HSIANG CHANG, (US)

(72) Inventor: WEN-KUEI CHANG, PINGTUNG HSIEN (TW)

(21) Appl. No.: 13/923,570

(22) Filed: Jun. 21, 2013

(51) Int. Cl. E05B 37/00

(52) U.S. Cl. CPC E05B 37/0031; E05B 37/0068
USPC 70/21

(57) ABSTRACT

A portable safety device includes a case, a lid and a shackle. The lid has a combination lock and a general lock connected thereto so as to lock the lid to the case. The shackle is removably connected to the case and controlled by either of the combination lock or the general lock. The shackle can position the safety device to an object and small items are stored in the space of the case.

### BACKGROUND OF THE INVENTION

1. Fields of the invention

The present invention relates to a portable safety device, and more particularly, to a portable safety device having a case in which small items are stored and the case is locked by a combination lock and a general lock.

2. Descriptions of Related Art

The conventional locks are roughly cataloged into combination locks and general locks, wherein the combination locks are unlocked by input correct numbers, and the general locks are unlocked by using a correct key. Most of the door locks are equipped with a key and if the key is lost or left in the house while the door is locked, the user cannot open the door. If the key is picked by an unauthorized person, the safety concern becomes a risky problem. Some people put the spare key under the welcome carpet in front of the door so that when the key is lost, the user can use the spare key to access the house. However, the spare key may be found by unauthorized person who may access the house to steal property in the house.

Besides, when parents are not at home and the children are back from school without the key, the children could be in danger during the period before the parents come back. If the parents want to leave a message to the kids and attach a note on the door, the note may be removed, flown away or ignored by the kids.

Thus a padlock with a receiving space is provided in Taiwan Utility Model No. 543693. Another Taiwan Utility Model No. M298000 discloses a lock assembly which has a case with an insertion hole and a pivotal hole. A shackle has a hook portion and a rod portion which is connected to one end the hook portion, wherein the rod portion is axially and movably connected to the pivotal hole, and the hook portion is removably inserted into the insertion hole. Another Taiwan Utility Model No. 301259 discloses a lock assembly which has a case with an opening, a space defined in the case, two insertion holes and multiple through holes. A combination lock is connected to the case and has number wheels and a movable grid plate. The number wheels are partially located in the through holes and the movable grid plate is driven by the number wheels and moved between a locked position and an unlocked position. A box is movably received in the space via the opening of the case. The box has a recess in which the movable grid plate is engaged. A hook has two ends thereof inserted into the two insertion holes and has a restriction portion which is engaged with the box.

U.S. Pat. No. 4,649,723 discloses a portable safe having a storage case, a padlock and a lid which has a combination lock connected thereto so as to lock the padlock to the storage case. The padlock is able to hook the portable safe to a fixed object.

These prior art references generally have a case with a space therein and a shackle which can be separated from the case so that the case can be locked to an object such as the door knob or handle, and small items such as keys, notes or cards lock can be stored in the space. The items can be accessed by one who knows the combination numbers.

However, there is only one combination lock available, if the user forget the correct numbers, the case cannot be opened, and the small items cannot be accessed.

The present invention intends to provide a portable safety device with two different locks from either of which the case can be opened.

### SUMMARY OF THE INVENTION

The present invention relates to a portable safety device and comprises a case, a lid and a shackle. The lid has a combination lock and a general lock connected thereto so as to lock the lid to the case. A shackle is removably connected to the case and controlled by either of the combination lock or the general lock. The shackle can position the safety device to an object and small items are stored in the space of the case.

Preferably, two grooves are defined in the inside of the space of the case and the lid is engaged with the grooves.

Preferably, the shackle has a plastic coat mounted thereto.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the portable safety device of the present invention;

FIG. 2 is a perspective view to show the portable safety device of the present invention;

FIG. 3 is a cross sectional view to show the portable safety device of the present invention, and

FIG. 4 is a cross sectional view to show that the shackle is separated from the case of the portable safety device of the present invention.

### DETAILED DESCRIPTION OF THE PREFERRED EMBODIMENT

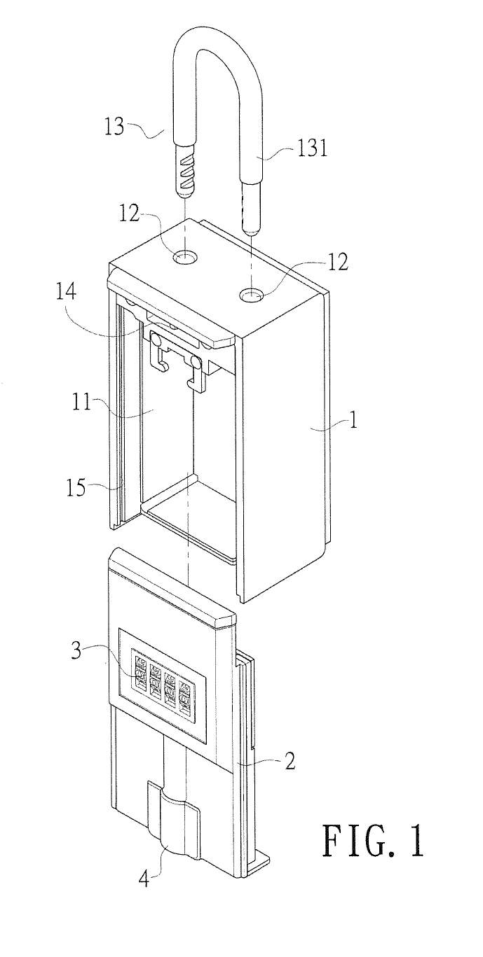

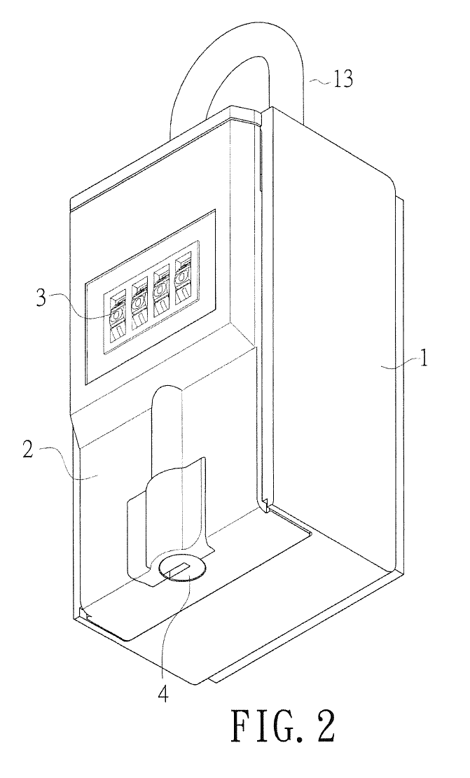

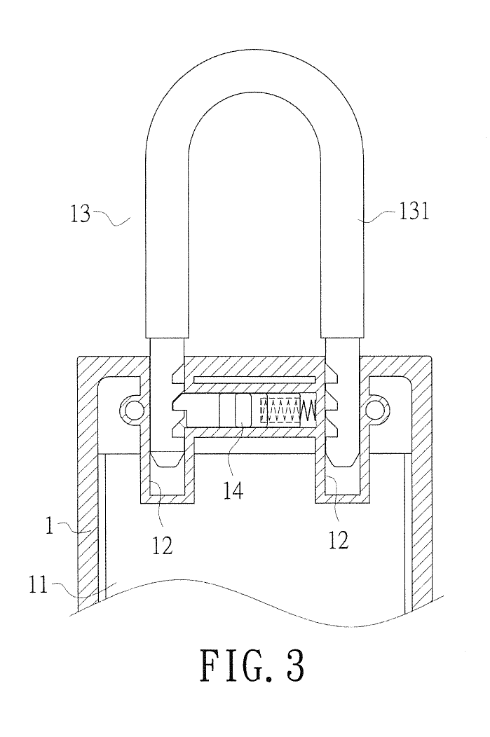

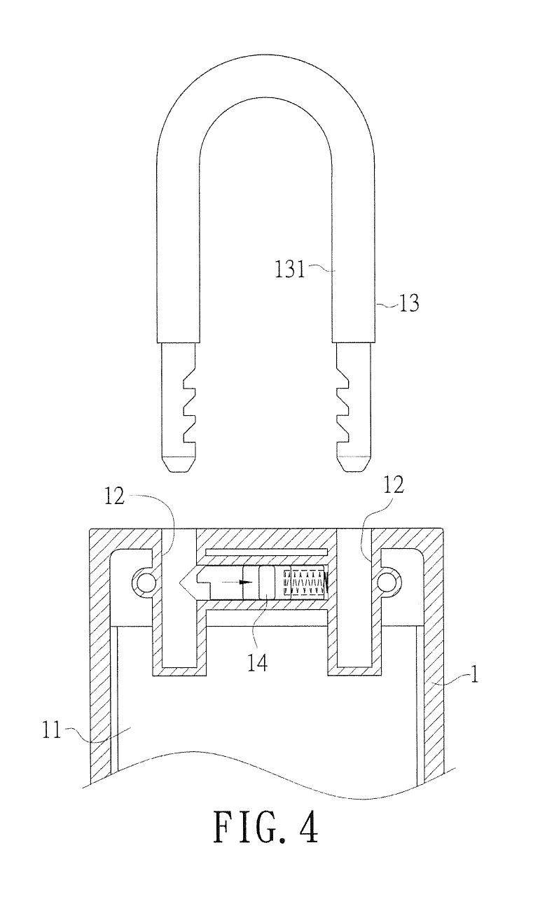

Referring to FIGS. 1 to 4, the portable safety device of the present invention comprises a case 1 having a space 11 defined therein, and two holes 12 are defined through the wall of the case 1 so that two ends of a shackle 13 are removably inserted into the two holes 12. The space 11 has a control unit 14 located therein and the control unit 14 is located corresponding to the two holes 12. The control unit 14 controls the shackle 13 to be connected to the case 1 or to be separated from the case 1. A lid 2 is movably mounted to the case 1 and closes the space 11. A combination lock 3 for locking the lid 2 to the case 1 by combination numbers is connected to the lid 2. A general lock 4 for locking the lid 2 to the case 1 by using a key is connected to the lid 2.

Before use, the shackle 13 is separated from the case 1, and the user can position the case 1 to a desired object such as a door knob, a rod or the like by inserting the two ends of the shackle 13 to the holes 12. The control unit 14 is activated to lock the shackle 13 to the case 1, so that the portable safety device is positioned on the desired object. The shackle 13 has a plastic coat 131 mounted thereto so as to protect the object. Small items such as keys, notes, precise objects or personal objects are stored in the space 11 of the case 1. The lid 2 is then connected to the case 1 and closes the space 11. Two grooves 15 are defined in the inside of the space 11 of the case 1 and the lid 2 is slidably engaged with the grooves 15. The lid 2 is locked to the case 1 by using correct combination numbers or a correct key.

When accessing the small items in the space 11, the user inputs correct combination numbers or uses a correct key to unlock the combination lock 3 or the general lock 4, the lid 2 can be removed from the case 1 and the space 11 is exposed. The combination lock 3 or the general lock 4 can also be located on the case 1.

The space 11 of the case 1 can be used as a small safety box and small items can be safely stored in the space 11. The lid 2 can be opened by either inputting correct combination numbers or using a correct key to unlock the combination lock 3 or the general lock 4.

The present invention provides two different locks, the combination lock 3 and the general lock 4 to obtain higher safety feature. The lid 2 can be opened by unlocking either of the combination lock 3 or the general lock 4.

The case 1 with the space 11 can be used as a safety box in which keys, notes or even jewelry can stored therein.

While we have shown and described the embodiment in accordance with the present invention, it should be clear to those skilled in the art that further embodiments may be made without departing from the scope of the present invention.

What is claimed is:

1. A portable safety device comprising:
a case having a space defined therein, two holes defined through a wall of the case, a shackle removably inserted into the two holes, the space having a control unit located therein and the control unit located corresponding to the two holes;
a lid movably mounted to the case and closing the space;
a combination lock for locking the lid to the case by combination numbers, and
a general lock for locking the lid to the case by using a key.

2. The device as claimed in claim 1, wherein the combination lock for locking the lid to the case by combination numbers is connected to the lid.

3. The device as claimed in claim 1, wherein the general lock for locking the lid to the case by using a key is connected to the lid.

4. The device as claimed in claim 1, wherein two grooves are defined in an inside of the space of the case and the lid is engaged with the grooves.

5. The device as claimed in claim 2, wherein the general lock for locking the lid to the case by using a key is connected to the lid.

6. The device as claimed in claim 2, wherein two grooves are defined in an inside of the space of the case and the lid is engaged with the grooves.

7. The device as claimed in claim 3, wherein two grooves are defined in an inside of the space of the case and the lid is engaged with the grooves.

8. The device as claimed in claim 4, wherein two grooves are defined in an inside of the space of the case and the lid is engaged with the grooves.
